(19) United States
(12) Patent Application Publication
(10) Pub. No.: US 2023/0419381 A1
(43) Pub. Date: Dec. 28, 2023

(54) MACHINE LEARNED MODEL FOR MANAGING FOUNDATIONAL ITEMS IN CONCIERGE SYSTEM

(71) Applicant: Maplebear Inc. (dba Instacart), San Francisco, CA (US)

(72) Inventors: Leho Nigul, Aurora (CA); Shaun Navin Maharaj, Vaughan (CA); Brent Scheibelhut, Toronto (CA)

(21) Appl. No.: 17/846,887

(22) Filed: Jun. 22, 2022

(51) Int. Cl. G06Q 30/06

(52) U.S. Cl. CPC G06Q 30/0613

(57) ABSTRACT

An online concierge system receives, from a client device comprising a customer mobile application, an order comprising a list of one or more items for delivery to a destination location from a warehouse. The customer mobile application comprises a user interface. The online concierge system identifies a set of item groupings from a database that match the list of one or more items. The online concierge system applies the order and the set of item groupings to a machine learning model to produce a set of foundational items. The online concierge system sends for display, to the client device, an updated user interface comprising a foundational items graphical element that visually distinguishes the set of foundational items from other items in the list of one or more items.

### BACKGROUND

This disclosure relates generally to machine learning and more specifically to modeling item relationships to reduce inappropriate item substitutions and cancelations in a concierge system.

In current delivery fulfillment systems, pickers fulfill orders at a physical warehouse on behalf of customers as part of an online concierge service. A physical warehouse may be, for example, a grocery store. An online concierge system assigns lists of items to shoppers who collect the items in the warehouse. The items are then delivered to the customers by the shopper or by a separate delivery driver.

Often, some items in an order are more important than others. For example, a customer may order several items to make a particular recipe, such as hamburgers. If the grocery store is out of stock in one item, such as pickles, the customer likely still desires to receive the other items. However, if the grocery store is out of stock in a different item, such as ground beef, the customer is more likely to desire to cancel the order. Shoppers may recommend substitution items to customers when items in an order are out of stock, or may simply choose a substitution item on behalf of the customer. The substitution of an important item with an inappropriate alternative can cause customer dissatisfaction and item waste.

Determining which items in an order are most important without asking the customer can be technically difficult, one reason being the sheer amount of data to be analyzed, such as the number of potential recipes that could be prepared, without a great deal of contextual information to use in analyzing that data. As another example, a user may order several unrelated items, such as diapers, noodles, and coffee beans, leaving ambiguity regarding which item is most important to the order. Identifying the most important items in an order can reduce rates of item waste, customer dissatisfaction, and refunds due to orders missing important items. The identification of the most important items in an order based on the sparse information known to the system about the order makes identifying those important items a difficult technical challenge.

### SUMMARY

In accordance with one or more aspects of the disclosure, an online concierge system receives an order from a client device. The client device includes a customer mobile application. The customer mobile application includes a user interface. The order includes a list of one or more items for delivery to a destination location from a warehouse.

The online concierge system identifies a set of item groupings from a database of item groupings that match the list of one or more items. Each item grouping in the database of item groupings corresponds to a specific set of items. The online concierge system applies the order and the set of item groupings to a machine learning model to produce a set of foundational items including one or more items in the list of one or more items.

The online concierge system sends for display to the client device an updated user interface. The updated user interface includes a foundational items graphical element that visually distinguishes the set of foundational items from other items in the list of one or more items.

### BRIEF DESCRIPTION OF THE DRAWINGS

FIG. 1 is a block diagram of a system environment in which an online system, such an online concierge system, operates, according to one or more embodiments.

FIG. 2 illustrates an environment of an online shopping concierge service, according to one or more embodiments.

FIG. 3 is a diagram of an online shopping concierge system, according to one or more embodiments.

FIG. 4A is a diagram of a customer mobile application (CMA), according to one or more embodiments.

FIG. 4B is a diagram of a shopper mobile application (SMA), according to one or more embodiments.

FIG. 5 illustrates a simplified user interface of an ordering interface, according to one or more embodiments.

FIG. 6 is a flowchart illustrating a process of a concierge system, according to one or more embodiments.

The figures depict embodiments of the present disclosure for purposes of illustration only. Alternative embodiments of the structures and methods illustrated herein may be employed without departing from the principles, or benefits touted, of the disclosure described herein.

### DETAILED DESCRIPTION

### System Architecture

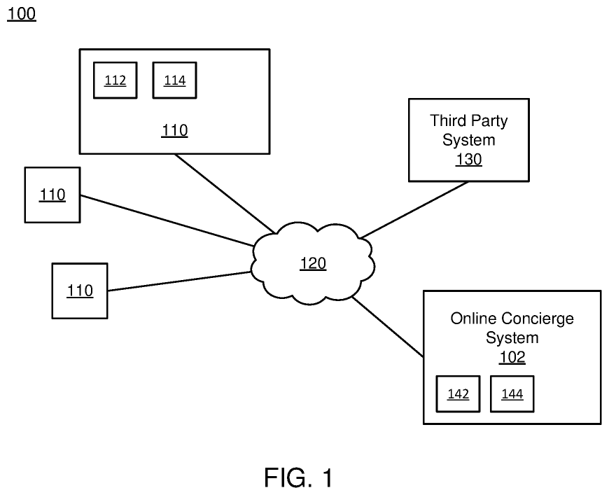

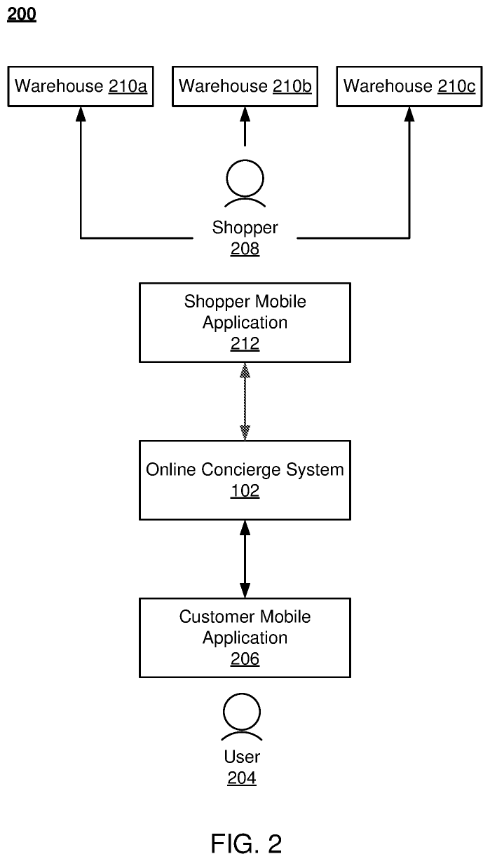

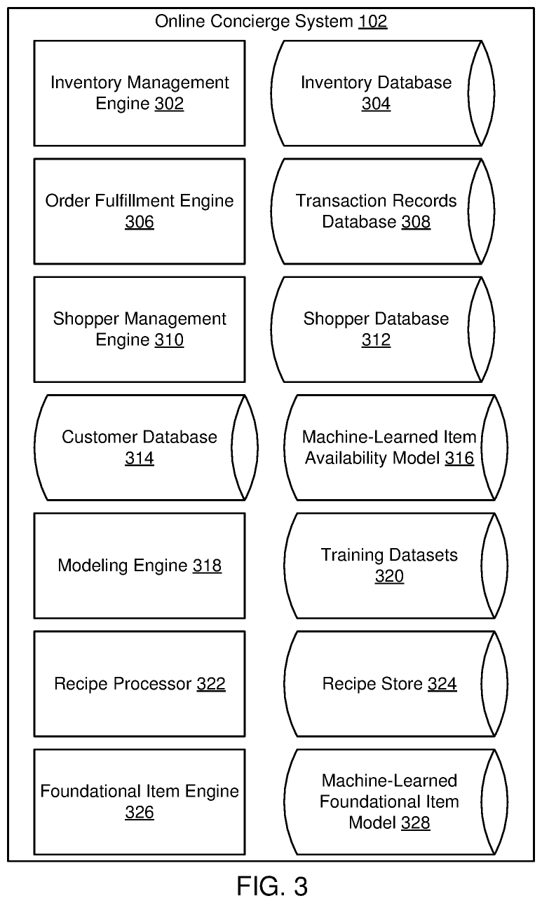

FIG. 1 is a block diagram of a system environment 100 in which an online system, such as an online concierge system 102 as further described below in conjunction with FIGS. 2 and 3, operates. The system environment 100 shown by FIG. 1 comprises one or more client devices 110, a network 120, one or more third-party systems 130, and the online concierge system 102. In alternative configurations, different and/or additional components may be included in the system environment 100. Additionally, in other embodiments, the online concierge system 102 may be replaced by an online system configured to retrieve content for display to users and to transmit the content to one or more client devices 110 for display.

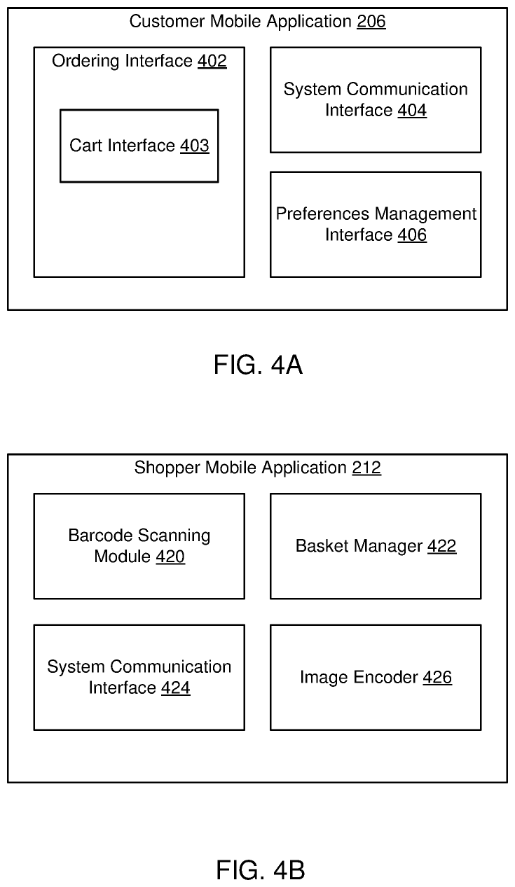

The client devices 110 are one or more computing devices capable of receiving user input as well as transmitting and/or receiving data via the network 120. In one embodiment, a client device 110 is a computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online concierge system 102. For example, the client device 110 executes a customer mobile application 206 or a shopper mobile application 212, as further described below in conjunction with FIGS. 4A and 4B, respectively, to enable interaction between the client device 110 and the online concierge system 102. As another example, a client device 110 executes a browser application to enable interaction between the client device 110 and the online concierge system 102 via the network 120. In another embodiment, a client device 110 interacts with the online concierge system 102 through an application programming interface (API) running on a native operating system of the client device 110, such as IOS® or ANDROID™.

A client device 110 includes one or more processors 112 configured to control operation of the client device 110 by performing functions. In various embodiments, a client device 110 includes a memory 114 comprising a non-transitory storage medium on which instructions are encoded. The memory 114 may have instructions encoded thereon that, when executed by the processor 112, cause the processor to perform functions to execute the customer mobile application 206 or the shopper mobile application 212 to provide the functions further described above in conjunction with FIGS. 4A and 4B, respectively.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online concierge system 102 or with the one or more client devices 110. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. For example, the third party system 130 stores one or more web pages and transmits the web pages to a client device 110 or to the online concierge system 102. The third party system 130 may also communicate information to the online concierge system 102, such as advertisements, content, or information about an application provided by the third party system 130.

In an embodiment, the system environment 100 includes one or more third party systems 130 that provide web content that includes third party system data, such as recipe information. A client device 110 can access the web content on the third party system 130 over the network 120 using a uniform resource locator (URL) of the web content. For example, a third party system 130 may be a remote server that hosts a food blog, which a client device 110 accesses over the network 120 using a URL that links to a web page of the food blog.

The web content includes contextual data that the online concierge system 102 can use to identify foundational item attributes. The online concierge system 102 can use the identified foundational item attributes as signals input to a machine learning model to produce a set of foundational items, as further described below.

In one or more embodiments, the web content includes contextual data such as recipe information including particular items, quantities of items, and so on; tags, such as hashtags, that identify particular items or item types; and/or parameters, such as URL parameters that identify one or more particular items, which the online concierge system 102 may detect and use as foundational item attributes. For example, the customer may use the client device 110 to access web content of the third party system 130, then the client device 110 may receive user input and responsively follow a link within the web content of the third party system 130. For example, the link may lead to a customer mobile application 206, or to a web page of a warehouse. The link may include URL parameters, which the customer mobile application 206 or warehouse web page sends to the online concierge system 102. Alternatively or additionally, the client device 110 and/or warehouse web page may identify the web content to the online concierge system 102, and the online concierge system 102 may then perform natural language processing upon the web content of the third party system 130 to produce the foundational item attributes.

The online concierge system 102 includes one or more processors 142 configured to control operation of the online concierge system 102 by performing functions. In various embodiments, the online concierge system 102 includes a memory 144 comprising a non-transitory storage medium on which instructions are encoded. The memory 144 may have instructions encoded thereon corresponding to the modules further below in conjunction with FIG. 3 that, when executed by the processor 142, cause the processor to perform the functionality further described above in conjunction with FIGS. 2-6. For example, the memory 144 has instructions encoded thereon that, when executed by the processor 142, cause the processor 142 to identify foundational items and recommend substitute items. Additionally, the online concierge system 102 includes a communication interface configured to connect the online concierge system 102 to one or more networks, such as network 120, or to otherwise communicate with devices (e.g., client devices 110) connected to the one or more networks.

One or more of a client device, a third party system 130, or the online concierge system 102 may be special purpose computing devices configured to perform specific functions, as further described below in conjunction with FIGS. 2-6, and may include specific computing components such as processors, memories, communication interfaces, and/or the like.

### System Overview

FIG. 2 illustrates an environment 200 of an online platform, such as an online concierge system 102, according to one embodiment. The figures use like reference numerals to identify like elements. A letter after a reference numeral, such as “210a,” indicates that the text refers specifically to the element having that particular reference numeral. A reference numeral in the text without a following letter, such as “210,” refers to any or all of the elements in the figures bearing that reference numeral. For example, “210” in the text refers to reference numerals “210a” or “210b” in the figures.

The environment 200 includes an online concierge system 102. The online concierge system 102 is configured to receive orders from one or more users 204 (only one is shown for the sake of simplicity). An order specifies a list of goods (items or products) to be delivered to the user 204. The order also specifies the location to which the goods are to be delivered, and a time window during which the goods should be delivered. In some embodiments, the order specifies one or more retailers from which the selected items should be purchased. The user may use a customer mobile application (CMA) 206 to place the order; the CMA 206 is configured to communicate with the online concierge system 102.

The online concierge system 102 is configured to transmit orders received from users 204 to one or more shoppers 208. A shopper 208 may be a contractor, employee, other person (or entity), robot, or other autonomous device enabled to fulfill orders received by the online concierge system 202. The shopper 208 travels between a warehouse and a delivery location (e.g., the user's home or office). A shopper 208 may travel by car, truck, bicycle, scooter, foot, or other mode of transportation. In some embodiments, the delivery may be partially or fully automated, e.g., using a self-driving car. The environment 200 also includes three warehouses 210a, 210b, and 210c (only three are shown for the sake of simplicity; the environment could include hundreds of warehouses). The warehouses 210 may be physical retailers, such as grocery stores, discount stores, department stores, etc., or non-public warehouses storing items that can be collected and delivered to users. Each shopper 208 fulfills an order received from the online concierge system 102 at one or more warehouses 210, delivers the order to the user 204, or performs both fulfillment and delivery. The order includes a list of one or more items for delivery. In one embodiment, shoppers 208 make use of a shopper mobile application 212 which is configured to interact with the online concierge system 102.

FIG. 3 is a diagram of an online concierge system 102, according to one embodiment. In various embodiments, the online concierge system 102 may include different or additional modules than those described in conjunction with FIG. 3. Further, in some embodiments, the online concierge system 102 includes fewer modules than those described in conjunction with FIG. 3.

The online concierge system 102 includes an inventory management engine 302, which interacts with inventory systems associated with each warehouse 210. In one embodiment, the inventory management engine 302 requests and receives inventory information maintained by the warehouse 210. The inventory of each warehouse 210 is unique and may change over time. The inventory management engine 302 monitors changes in inventory for each participating warehouse 210. The inventory management engine 302 is also configured to store inventory records in an inventory database 304. The inventory database 304 may store information in separate records—one for each participating warehouse 210—or may consolidate or combine inventory information into a unified record. Inventory information includes attributes of items that include both qualitative and qualitative information about items, including size, color, weight, SKU, serial number, and so on. In one embodiment, the inventory database 304 also stores purchasing rules associated with each item if they exist. For example, age-restricted items such as alcohol and tobacco are flagged accordingly in the inventory database 304. Additional inventory information useful for predicting the availability of items may also be stored in the inventory database 304. For example, for each item-warehouse combination (a particular item at a particular warehouse), the inventory database 304 may store a time that the item was last found, a time that the item was last not found (a shopper looked for the item but could not find it), the rate at which the item is found, and the popularity of the item.

For each item, the inventory database 304 identifies one or more attributes of the item and corresponding values for each attribute of an item. For example, the inventory database 304 includes an entry for each item offered by a warehouse 210, with an entry for an item including an item identifier that uniquely identifies the item. The entry includes different fields, with each field corresponding to an attribute of the item. A field of an entry includes a value for the attribute corresponding to the attribute for the field, allowing the inventory database 304 to maintain values of different categories for various items.

In various embodiments, the inventory management engine 302 maintains a taxonomy of items offered for purchase by one or more warehouses 210. For example, the inventory management engine 302 receives an item catalog from a warehouse 210 identifying items offered for purchase by the warehouse 210. From the item catalog, the inventory management engine 202 determines a taxonomy of items offered by the warehouse 210. different levels in the taxonomy providing different levels of specificity about items included in the levels. In various embodiments, the taxonomy identifies a category and associates one or more specific items with the category. For example, a category identifies “milk,” and the taxonomy associates identifiers of different milk items (e.g., milk offered by different brands, milk having one or more different attributes, etc.), with the category. Thus, the taxonomy maintains associations between a category and specific items offered by the warehouse 210 matching the category. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a category, while items in higher levels of the hierarchical taxonomy have a fewer number of attributes, corresponding to less specificity in a category. In various embodiments, higher levels in the taxonomy include less detail about items, so greater numbers of items are included in higher levels (e.g., higher levels include a greater number of items satisfying a broader category). Similarly, lower levels in the taxonomy include greater detail about items, so fewer numbers of items are included in the lower levels (e.g., higher levels include a fewer number of items satisfying a more specific category). The taxonomy may be received from a warehouse 210 in various embodiments. In other embodiments, the inventory management engine 302 applies a trained classification module to an item catalog received from a warehouse 210 to include different items in levels of the taxonomy, so application of the trained classification model associates specific items with categories corresponding to levels within the taxonomy.

Inventory information provided by the inventory management engine 302 may supplement the training datasets 320. Inventory information provided by the inventory management engine 302 may not necessarily include information about the outcome of picking a delivery order associated with the item, whereas the data within the training datasets 320 is structured to include an outcome of picking a delivery order (e.g., if the item in an order was picked or not picked).

In one or more embodiments, the online concierge system 102 includes a database of item groupings. Each item grouping is a set of items stored in the inventory database 304. For example, an item grouping may be a recipe that includes five ingredients, where each ingredient is an item recorded in the inventory database 304. As another example, an item grouping may be a set of related items, such as diapers, baby formula, and wet wipes. The online concierge system 102 may update over time. For example, an administrator of the online concierge system 102 may add and/or remove item groupings to the database of item groupings. In one or more embodiments, the online concierge system 102 receives item groupings from one or more third party systems 130, such as a remote server of an organization that provides recipes via a website hosted by the remote server.

The online concierge system 102 also includes an order fulfillment engine 306 which is configured to synthesize and display an ordering interface to each user 204 (for example, via the customer mobile application 206). The order fulfillment engine 306 is also configured to access the inventory database 304 in order to determine which products are available at which warehouse 210. The order fulfillment engine 306 may supplement the product availability information from the inventory database 234 with an item availability predicted by the machine-learned item availability model 316. The order fulfillment engine 306 determines a sale price for each item ordered by a user 204. Prices set by the order fulfillment engine 306 may or may not be identical to in-store prices determined by retailers (which is the price that users 204 and shoppers 208 would pay at the retail warehouses). The order fulfillment engine 306 also facilitates transactions associated with each order. In one embodiment, the order fulfillment engine 306 charges a payment instrument associated with a user 204 when he/she places an order. The order fulfillment engine 306 may transmit payment information to an external payment gateway or payment processor. The order fulfillment engine 306 stores payment and transactional information associated with each order in a transaction records database 308.

In various embodiments, the order fulfillment engine 306 generates and transmits a search interface to a client device of a user for display via the customer mobile application 106. The order fulfillment engine 306 receives a query comprising one or more terms from a user and retrieves items satisfying the query, such as items having descriptive information matching at least a portion of the query. In various embodiments, the order fulfillment engine 306 leverages item embeddings for items to retrieve items based on a received query. For example, the order fulfillment engine 306 generates an embedding for a query and determines measures of similarity between the embedding for the query and item embeddings for various items included in the inventory database 304.

In some embodiments, the order fulfillment engine 306 also shares order details with warehouses 210. For example, after successful fulfillment of an order, the order fulfillment engine 306 may transmit a summary of the order to the appropriate warehouses 210. The summary may indicate the items purchased, the total value of the items, and in some cases, an identity of the shopper 208 and user 204 associated with the transaction. In one embodiment, the order fulfillment engine 306 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 306, which provides detail of all orders which have been processed since the last request.

The order fulfillment engine 306 may interact with a shopper management engine 310, which manages communication with and utilization of shoppers 208. In one embodiment, the shopper management engine 310 receives a new order from the order fulfillment engine 306. The shopper management engine 310 identifies the appropriate warehouse 210 to fulfill the order based on one or more parameters, such as a probability of item availability determined by a machine-learned item availability model 316, the contents of the order, the inventory of the warehouses, and the proximity to the delivery location. The shopper management engine 310 then identifies one or more appropriate shoppers 208 to fulfill the order based on one or more parameters, such as the shoppers' proximity to the appropriate warehouse 210 (and/or to the user 204), his/her familiarity level with that particular warehouse 210, and so on. Additionally, the shopper management engine 310 accesses a shopper database 312 which stores information describing each shopper 208, such as his/her name, gender, rating, previous shopping history, and so on.

As part of fulfilling an order, the order fulfillment engine 306 and/or shopper management engine 310 may access a user database 314 which stores information describing each user. This information could include each user's name, address, gender, shopping preferences, favorite items, stored payment instruments, and so on. In various embodiments, the order fulfillment engine 306 determines whether to delay display of a received order to shoppers for fulfillment by a time interval. In response to determining to delay the received order by a time interval, the order fulfilment engine 306 evaluates orders received after the received order and during the time interval for inclusion in one or more batches that also include the received order. After the time interval, the order fulfillment engine 306 displays the order to one or more shoppers via the shopper mobile application 212; if the order fulfillment engine 306 generated one or more batches including the received order and one or more orders received after the received order and during the time interval, the one or more batches are also displayed to one or more shoppers via the shopper mobile application 212.

### Machine Learning Models

The online concierge system 102 further includes a machine-learned item availability model 316, a modeling engine 318, and training datasets 320. The modeling engine 318 uses the training datasets 320 to generate the machine-learned item availability model 316. The machine-learned item availability model 316 can learn from the training datasets 320, rather than follow only explicitly programmed instructions. The inventory management engine 302, order fulfillment engine 306, and/or shopper management engine 310 can use the machine-learned item availability model 316 to determine a probability that an item is available at a warehouse 210. The machine-learned item availability model 316 may be used to predict item availability for items being displayed to or selected by a user or included in received delivery orders. A single machine-learned item availability model 316 is used to predict the availability of any number of items.

The machine-learned item availability model 316 can be configured to receive as inputs information about an item, the warehouse for picking the item, and the time for picking the item. The machine-learned item availability model 316 may be adapted to receive any information that the modeling engine 318 identifies as indicators of item availability. At minimum, the machine-learned item availability model 316 receives information about an item-warehouse pair, such as an item in a delivery order and a warehouse at which the order could be fulfilled. Items stored in the inventory database 304 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 304. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 304 and/or warehouse database and provide this extracted information as inputs to the item availability model 316.

The machine-learned item availability model 316 contains a set of functions generated by the modeling engine 318 from the training datasets 320 that relate the item, warehouse, and timing information, and/or any other relevant inputs, to the probability that the item is available at a warehouse. Thus, for a given item-warehouse pair, the machine-learned item availability model 316 outputs a probability that the item is available at the warehouse. The machine-learned item availability model 316 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 316 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper or predicted to be unavailable but found by the shopper). In some examples, the confidence score is based in part on the age of the data for the item, e.g., if availability information has been received within the past hour, or the past day. The set of functions of the item availability model 316 may be updated and adapted following retraining with new training datasets 320. The machine-learned item availability model 316 may be any machine learning model, such as a neural network, boosted tree, gradient boosted tree or random forest model. In some examples, the machine-learned item availability model 316 is generated from XGBoost algorithm.

The item probability generated by the machine-learned item availability model 316 may be used to determine instructions delivered to the user 204 and/or shopper 208, as described in further detail below.

The training datasets 320 relate a variety of different factors to known item availabilities from the outcomes of previous delivery orders (e.g., if an item was previously found or previously unavailable). The training datasets 320 include the items included in previous delivery orders, whether the items in the previous delivery orders were picked, warehouses associated with the previous delivery orders, and a variety of characteristics associated with each of the items (which may be obtained from the inventory database 204). Each piece of data in the training datasets 320 includes the outcome of a previous delivery order (e.g., if the item was picked or not). The item characteristics may be determined by the machine-learned item availability model 316 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 316 may weight these factors differently, where the weights are a result of a “learning” or training process on the training datasets 320. The training datasets 320 are very large datasets taken across a wide cross section of warehouses, shoppers, items, warehouses, delivery orders, times, and item characteristics. The training datasets 320 are large enough to provide a mapping from an item in an order to a probability that the item is available at a warehouse. In addition to previous delivery orders, the training datasets 320 may be supplemented by inventory information provided by the inventory management engine 302. In some examples, the training datasets 320 are historic delivery order information used to train the machine-learned item availability model 316, whereas the inventory information stored in the inventory database 304 include factors input into the machine-learned item availability model 316 to determine an item availability for an item in a newly received delivery order. In some examples, the modeling engine 318 may evaluate the training datasets 320 to compare a single item's availability across multiple warehouses to determine if an item is chronically unavailable. This may indicate that an item is no longer manufactured. The modeling engine 318 may query a warehouse 210 through the inventory management engine 302 for updated item information on these identified items.

### Machine Learning Factors

The training datasets 320 include a time associated with previous delivery orders. In some embodiments, the training datasets 320 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 320 include a day of the week previous delivery orders were placed. The day of the week may impact item availability since popular shopping days may have reduced inventory of items or restocking shipments may be received on particular days. In some embodiments, training datasets 320 include a time interval since an item was previously picked in a previously delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 320 include a time interval since an item was not found in a previous delivery order. If there has been a short time interval since an item was not found, this may indicate that there is a low probability that the item is available in subsequent delivery orders. And conversely, if there is has been a long time interval since an item was not found, this may indicate that the item may have been restocked and is available for subsequent delivery orders. In some examples, training datasets 320 may also include a rate at which an item is typically found by a shopper at a warehouse, a number of days since inventory information about the item was last received from the inventory management engine 302, a number of times an item was not found in a previous week, or any number of additional rate or time information. The relationships between this time information and item availability are determined by the modeling engine 318 training a machine learning model with the training datasets 320, producing the machine-learned item availability model 316.

The training datasets 320 include item characteristics. In some examples, the item characteristics include a department associated with the item. For example, if the item is yogurt, it is associated with the dairy department. The department may be the bakery, beverage, nonfood, and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 302. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 318 training a machine learning model with the training datasets 320, producing the machine-learned item availability model 316.

The training datasets 320 may include additional item characteristics that affect the item availability and can therefore be used to build the machine-learned item availability model 316 relating the delivery order for an item to its predicted availability. The training datasets 320 may be periodically updated with recent previous delivery orders. The training datasets 320 may be updated with item availability information provided directly from shoppers 208. Following updating of the training datasets 320, a modeling engine 318 may retrain a model with the updated training datasets 320 and produce a new machine-learned item availability model 316.

In one or more embodiments, the online concierge system 102 includes a machine learning model that predicts whether an item is available, at least as described in patent application Ser. No. 17/069,741, filed Oct. 13, 2020, titled “Identifying Candidate Replacement Items from a Graph identifying Relationships Between Items Maintained by an Online Concierge System,” which is incorporated by reference herein. In one or more embodiments, the online concierge system 102 includes a machine learning model that predicts whether an item is available at a specific warehouse 210, at least as described in patent application Ser. No. 17/524,469, filed Nov. 11, 2021, titled “Replacing One or More Generic Item Descriptions in a Recipe to Accommodate User Preferences for Items Based on Determined Relationships Between Generic Item Descriptions,” which is incorporated by reference herein.

### Recipe Processor:

The online concierge system 102 further includes a recipe processor 322 and a recipe store 324. The recipe processor 322 obtains recipes from one or more sources. A recipe includes one or more items, such as a plurality of items, a quantity of each item, and may also include information describing how to combine the items in the recipe. Recipes may be obtained from users, third party systems (e.g., websites, applications), or any other suitable source and stored in the recipe store 324. Additionally, each recipe has one or more attributes describing the recipe. Example attributes of a recipe include an amount of time to prepare the recipe, a complexity of the recipe, nutritional information about the recipe, a genre of the recipe, or any other suitable information. Attributes of a recipe may be included in the recipe by a source from which the recipe was received or may be determined by the online concierge system 102 from items in the recipe or other information included in the recipe.

### Recipe Store:

The recipe store 324 includes information identifying recipes obtained by the online concierge system 102. A recipe includes one or more items, such as a plurality of items, a quantity of each item, and may also include information describing how to combine the items in the recipe. Recipes may be obtained from users, third party systems (e.g., websites, applications), or any other suitable source and stored in the recipe store 324. Additionally, each recipe has one or more attributes describing the recipe. Example attributes of a recipe include an amount of time to prepare the recipe, a complexity of the recipe, nutritional information about the recipe, a genre of the recipe, or any other suitable information. Attributes of a recipe may be included in the recipe by a source from which the recipe was received or may be determined by the online concierge system 102 from items in the recipe or other information included in the recipe.

Additionally, the recipe store 324 maintains a recipe graph identifying connections between recipes in the recipe store 324 in one or more embodiments. A connection between a recipe and another recipe indicates that the connected recipes each have one or more common attributes. In some embodiments, a connection between a recipe and another recipe indicates that a user included items from each connected recipe in a common order or included items from each connected recipe in orders the online concierge system received from the user within a threshold amount of time from each other. In various embodiments, each connection between recipes includes a value, with the value providing an indication of a strength of a connection between the recipes.

### Foundational Items

The online concierge system 102 further includes a foundational item engine 326 and a machine-learned foundational item model 328. A foundational item is an item in an order that the online concierge system 102 identifies as an item that the shopper cannot fail to fulfill when completing the order. For example, if an order includes chicken, parmesan cheese, tomato sauce, spaghetti noodles, broccoli, and carrots, the chicken may be identified by the online concierge system 102 as a foundational item while the carrots may not be identified by the online concierge system 102 as a foundational item. Fulfilling a foundational item can include delivery of the foundational item to the destination location, delivery of a substitute item to the destination location, and/or the sending by the online concierge system 102 of a notification to the customer mobile application that the foundational item is unavailable, as described further below.

The online concierge system 102 receives an order and queries the database of item groupings to identify item groupings that correspond to the order. For example, the online concierge system 102 identifies item groupings that include one or more items included in the order. In one or more embodiments, the online concierge system 102 applies the order to an item grouping machine learning model to identify the item groupings. The item grouping machine learning model may be trained on item groupings and lists of items tagged with one or more item groupings such that the item grouping machine learning model can generate a score indicating a likelihood that an item grouping matches a list of items (e.g., a list of items in an order). In one or more embodiments, the online concierge system 102 applies the order to the item grouping machine learning model and identifies as the identified item groupings one or more item groupings with scores exceeding an item grouping threshold score.

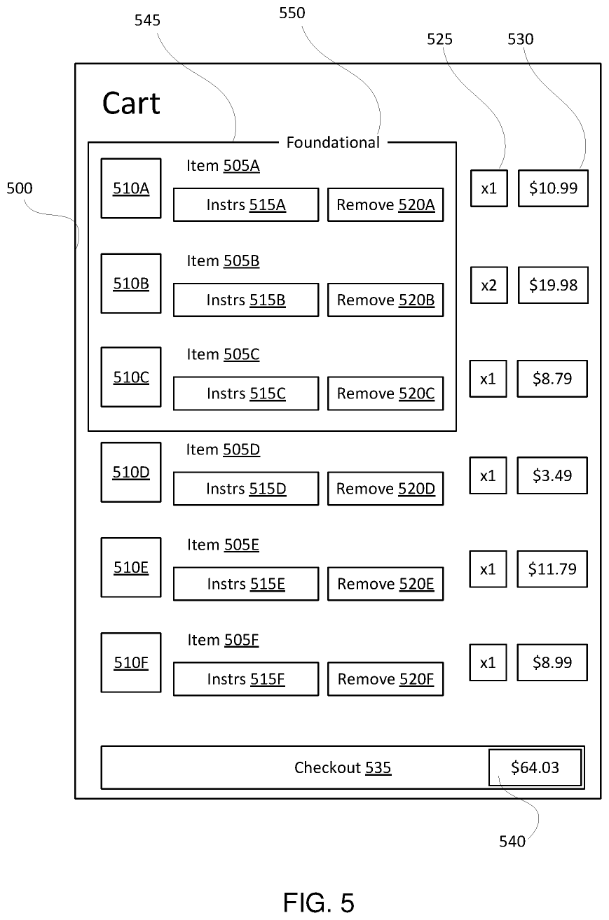

The online concierge system 102 uses the machine-learned foundational item model 328 to determine the foundational items for an order. The foundational item engine 326 applies the order and the set of item groupings identified by the online concierge system 102 to the machine-learned foundational item model 328 to produce a set of foundational items. Each foundational item in the set of foundational items is an item in the order. The online concierge system 102 sends an updated user interface to the client device that includes a foundational items graphical element that visually distinguishes the set of foundational items from other items in the order. The user interface is further described below with reference to FIG. 5.

In one or more embodiments, the foundational item engine 326 determines whether each foundational item in the set of foundational items is available at one or more warehouses. If the foundational item engine 326 determines that one or more of the foundational items is unavailable, the foundational item engine 326 performs one or more remedial actions. One remedial action can involve identifying one or more item substitutes for each unavailable foundational item and sending a notification to the customer mobile application indicating the foundational item is unavailable and identifying the one or more item substitutes. The foundational item engine 326 may receive from the customer mobile application an instruction to cancel the order, in response to which the online concierge system 102 cancels the order, and/or the foundational item engine 326 may receive from the customer mobile application an instruction to replace the foundational item with a particular item substitute, in which case the foundational item engine 326 sends a notification to the shopper mobile application to substitute the item substitute for the foundational item.

In one or more embodiments, the one or more remedial actions can involve the foundational item engine 326 identifies one or more alternative item groupings that include an unavailable foundational item and sends a notification to the customer mobile application that the foundational item is unavailable. The notification identifies the one or more alternative item groupings. The foundational item engine 326 may identify the one or more alternative item groupings by using the item grouping machine learning model to identify item groupings using the list of items in the order, excluding the one or more items that are unavailable.

In one or more embodiments, the one or more remedial actions can involve the foundational item engine 326 identifies an alternative warehouse at which the particular foundational item is available and sends to the shopper mobile application an instruction to fulfill the order at the alternative warehouse.

In one or more embodiments, the foundational items engine 326 receives from the customer mobile application a notification that one or more identified foundational items are not actually foundational to the order. The foundational items engine 326 may remove the one or more items that are not actually foundational from the set of foundational items and use one or more attributes of the notification and/or the order as a signal to update the machine-learned foundational item model 328. The foundational items engine 326 may send an updated user interface to the customer mobile application to adjust such that the removed one or more items are not visually distinguished as foundational.

In one or more embodiments, the foundational items engine 326 identifies foundational item attributes based on the contextual data. The contextual data is third party system 130 data received from the customer mobile application 206. For example, the customer mobile application 206 determines that the client device 110 accessed web content that includes third party system 130 data. The customer mobile application 206 collects the third party system 130 data and sends it to the foundational items engine 326. The foundational items engine 326 may analyze the third party system 130 data, e.g., using a machine learning model for natural language processing, to identify foundational item attributes, such as one or more item names. In such an embodiment, the foundational items engine 326 may additionally apply the foundational item attributes as signals to the machine-learned foundational item model 328 when generating the set of foundational items.

In one or more embodiments, the foundational items engine 326 identifies a user profile associated with the customer mobile application from which the order was received. The user profile includes user profile data, which may include past order data such as historical orders, respective satisfaction notifications submitted to the customer mobile application by the user, information regarding canceled orders, frequently ordered items, item restrictions specified by user input (e.g., a restriction on meat items for a user profile for which the user activated a “vegetarian” option), and so on. The foundational items engine 326 may use the user profile data when identifying the set of item groupings. For example, the user profile data may be used as signals to the item grouping machine learning model, and/or may be used to filter the item groupings scored by the item grouping machine learning model (e.g., to remove restricted items, such as items of type “meat” for a user with a “vegetarian” option activated).

In one or more embodiments, the foundational items engine 326 receives feedback data for the order from the customer mobile application, e.g., after fulfillment of the order. The foundational items engine 326 uses the feedback data to update the machine-learned foundational item model 328. For example, negative feedback associated with an order for which one non-foundational item could not be fulfilled may adjust the machine-learned foundational item model 328 to subsequently identify the one non-foundational item as more likely to be foundational.

In one or more embodiments, in addition to using the machine-learned foundational item model 328 or as an alternative, the foundational items engine 326 uses a set of heuristic rules to identify one or more foundational items. For example, the foundational items engine 326 may apply the set of heuristic rules to the order to identify a set of foundational items, and/or apply the order to the machine-learned foundational item model 328, e.g., to expand the set of foundational items. In one or more embodiments, a heuristic rule in the set of heuristic rules includes the first item added to an order is a foundational item. In one or more embodiments, a heuristic rule in the set of heuristic rules includes if the number of items in the order is fewer than a number of items threshold, then all items in the order are foundational. In one or more embodiments, a heuristic rule in the set of heuristic rules includes if a quantity of an item exceeds an item quantity threshold, the item is a foundational item. In one or more embodiments, a heuristic rule in the set of heuristic rules includes if a plurality of items in the order are highly correlated (e.g., in the taxonomy of items, such as “hotdogs” and “hotdog buns”), the plurality of items are foundational items. In one or more embodiments, a heuristic rule in the set of heuristic rules includes items in the order of particular item types are foundational items. For example, the taxonomy of items may include as an attribute of each item an item type. The foundational items engine 326 may check the item type of each item in the order by querying the taxonomy of items. Particular item types, such as “meat,” may be foundational.

The machine-learned foundational item model 328 is generated by the foundational items engine 326 using foundational items training data, which can include some or all of the training datasets 320 described above, depending upon the embodiment. The machine-learned foundational item model 328 can learn from the foundational items training data, rather than follow only explicitly programmed instructions. The foundational items engine 326 can use the machine-learned foundational item model 328 to determine a probability that an item is foundational. The machine-learned foundational item model 328 may be used to predict whether an item is foundational for items being displayed to or selected by a user or included in received delivery orders. A single machine-learned foundational item model 328 is used to predict whether an item is foundational for any number of items.

The machine-learned foundational item model 328 can be configured to receive as inputs information about an item, contextual data, user profile data, the list of items in the order, and/or the identified item groupings. The machine-learned item availability model 316 may be adapted to receive any information that the modeling engine 318 identifies as indicators of the item being foundational. At minimum, the machine-learned item availability model 316 receives the list of items in the order.

The machine-learned foundational item model 328 contains a set of functions generated by the foundational items engine 326, from the foundational items training data, that relate the inputs to the probability that an item is foundational. Thus, for a given item in an order, the machine-learned foundational item model 328 outputs a probability that the item is foundational. The machine-learned foundational item model 328 constructs the relationship between the inputs and the foundational item probability. In some embodiments, the probability output by the machine-learned foundational item model 328 includes a confidence score. The confidence score may be the error or uncertainty score of the output probability and may be calculated using any standard statistical error measurement. In some examples, the confidence score is based in part on whether the foundational item prediction was accurate for previous orders (e.g., if the item was predicted to be foundational and the online concierge system 102 receives a notification that the item is not foundational from the customer mobile application). The set of functions of the machine-learned foundational item model 328 may be updated and adapted following retraining with new data. The machine-learned foundational item model 328 may be any machine learning model, such as a neural network, boosted tree, gradient boosted tree or random forest model. In some examples, the machine-learned item availability model 316 is generated from XGBoost algorithm.

The foundational items training data can include item groupings, such as the item groupings in the database of item groupings, where one or more items in one or more of the item groupings are labeled as foundational. The foundational items training data can also include one or more orders, historic or artificially constructed for training, where one or more items in each of the one or more orders is labeled as foundational. In one or more embodiments, the foundational items training data includes an item graph, where each item in the taxonomy of items is a node, and nodes are connected by edges to one another based on the item groupings in the database of item groupings, where two nodes share an edge if both items represented by the two nodes are in one or more item groupings together. The weight of each edge connecting two nodes may correspond to a number of item groupings that include both items represented by the two nodes, where a higher number corresponds to a greater weight. In one or more embodiments, the foundational items engine 326 may update the item graph over time, e.g., as new item groupings are added to the database of item groupings, and/or as the taxonomy of items changes (e.g., items are added or removed). In one or more embodiments, the foundational items training data can include browsing information (of users, within the customer mobile application) that corresponds to orders in the one or more orders used for training. In one or more embodiments, the online concierge system 102 tracks item substitutions for items in orders and uses this collected information as foundational items training data.

### Customer Mobile Application

FIG. 4A is a diagram of the customer mobile application (CMA) 206, according to one embodiment. The CMA 206 includes an ordering interface 402, which provides an interactive interface with which the user 204 can browse through and select products and place an order. The CMA 206 also includes a system communication interface 404 which, among other functions, receives inventory information from the online shopping concierge system 102 and transmits order information to the system 202. The CMA 206 also includes a preferences management interface 406 which allows the user 204 to manage basic information associated with his/her account, such as his/her home address and payment instruments. The preferences management interface 406 may also allow the user to manage other details such as his/her favorite or preferred warehouses 210, preferred delivery times, special instructions for delivery, and so on.

The ordering interface 402 includes a cart interface 403, which displays items selected by the user 204 for ordering. As the user 204 uses the client device 110 to select items to order, the items are populated in the cart interface 403. In one or more embodiments, the cart interface 403 visualizes a list of selected items using one or more graphical elements for each selected item. The user 204 can use the cart interface 403 to manage foundational items, such as select a substitute item for a foundational item that is unavailable (e.g., out of stock at the warehouse 210). The cart interface 403 provides options for the user 204 to cancel the order and/or to place the order. Further details of one or more embodiments of the cart interface 403 are described below with reference to FIG. 5.

### Shopper Mobile Application

FIG. 4B is a diagram of the shopper mobile application (SMA) 212, according to one embodiment. The SMA 212 includes a barcode scanning module 420 which allows a shopper 208 to scan an item at a warehouse 210 (such as a can of soup on the shelf at a grocery store). The barcode scanning module 420 may also include an interface which allows the shopper 108 to manually enter information describing an item (such as its serial number, SKU, quantity and/or weight) if a barcode is not available to be scanned. SMA 212 also includes a basket manager 422 which maintains a running record of items collected by the shopper 208 for purchase at a warehouse 210. This running record of items is commonly known as a “basket” or “cart.” In one embodiment, the barcode scanning module 420 transmits information describing each item (such as its cost, quantity, weight, etc.) to the basket manager 422, which updates its basket accordingly. The SMA 212 also includes a system communication interface 424 which interacts with the online shopping concierge system 102. For example, the system communication interface 424 receives an order from the online concierge system 102 and transmits the contents of a basket of items to the online concierge system 102. The SMA 212 also includes an image encoder 426 which encodes the contents of a basket into an image. For example, the image encoder 426 may encode a basket of goods (with an identification of each item) into a QR code which can then be scanned by an employee of the warehouse 210 at check-out.

In an embodiment, for each foundational item identified in the cart that the online concierge system 102 identifies as unavailable, the shopper can input a suggested substitution item to the SMA 212 that the SMA 212 transmits to the CMA 206 for review. The user 204 can approve or decline the substitution via input to the CMA 206, and/or can request an alternative substitution item via input to the CMA 206, which is transmitted to the SMA 212.

### User Interfaces

FIG. 5 illustrates a simplified user interface (UI) 500 of an ordering interface 402, according to one or more embodiments. Specifically, the UI 500 illustrates a simplified cart interface 403 of the ordering interface 402, according to one or more embodiments. In one or more embodiments, some or all functionality of the cart interface 403 is instead provided by the ordering interface 402 without a separate cart interface 403. As mentioned above, the list of items displayed in the UI 500 may be referred to as a “cart.”

The UI 500 includes a list of items 505A-F selected by the user 204 for ordering. Although six items 505 are listed in the UI 500, alternative embodiments may include fewer or more items 505, e.g., the particular number of items selected for ordering by the user 204. Each item 505 is associated with a row in the list. For example, item 505A is in a row of the list alongside an item graphical element 510A that provides a visualization of the item 505A, e.g., a photo of the item 505A. In some instances, the UI 500 does not include item graphical elements 510.

Item 505A as listed in the UI 500 is also associated with an instructions graphical element 515A, a removal graphical element 520A, a quantity graphical element 525, and a price graphical element 530. Each item 505 in the UI 500 may be associated with a respective item graphical element 510, instructions graphical element 515, removal graphical element 520, quantity graphical element 525, and price graphical element 530. For example, item 505B is listed in association with item graphical element 510B, instructions graphical element 515B, and removal graphical element 520B, as well as a corresponding quantity graphical element and corresponding price graphical element different than those associated with the item 505A.

Each instructions graphical element 515 is associated with an item 505 in the cart. For example, instructions graphical element 515A corresponds to item 505A. The instructions graphical element 515 is selectable via user input to the UI 500. Upon selection, depending upon the embodiment, the instructions graphical element 515 provides one or more options by which the user 204 can customize the order (e.g., the UI 500 opens a menu upon selection of the instructions graphical element 515). One option may be to mark the item as foundational. One option may be to mark the item as not foundational. One option may be to select one or more potential substitute items (e.g., if the concierge system 102 identifies potential substitute items) and/or provide one or more potential substitute items for the item. One option may be to instruct the shopper to cancel the order if the item is unavailable, e.g., the CMA 206 sends the instruction to the SMA 212 and/or the online concierge system 102 (which may then send the instruction to the SMA 212). One option may be to instruct the shopper to cancel the order if at least a certain quantity of the item is not available. One option may be to save the current group of foundational items for future reuse. In an embodiment, the instructions graphical element 515, upon selection, opens a text box into which the user can enter textual instructions (e.g., via user input to the UI 500).

Each removal graphical element 520 is associated with an item 505 in the cart. For example, removal graphical element 515A corresponds to item 505A. The removal graphical element 520 is selectable via user input to the UI 500. Upon selection of the removal graphical element 520, the UI 500 removes the respective item from the cart. If the item removed by selection of the respective removal graphical element 515 was identified as foundational, the CMA 206 may send a notification to the online concierge system 102 that the item identified as foundational was removed. The online concierge system 120 may use the instruction to update the machine-learned foundational item model 328, e.g., to reduce the likelihood of the item being identified as foundational in subsequent uses of the machine-learned foundational item model 328.

The quantity graphical element 525 is associated with an item 505 in the cart. For example, quantity graphical element 525 is associated with item 505A. The quantity graphical element 525 indicates a quantity of the item in the cart. For example, the user 204 may add one or more copies of an item to the cart, and the quantity graphical element 525 reflects the number of copies of the item in the cart. The quantity graphical element 525 associated with item 505A reflects a quantity of one, while the quantity graphical element associated with item 505B reflects a quantity of two.

The price graphical element 530 is associated with an item 505 in the cart. For example, price graphical element 530 is associated with item 505A. The price graphical element 530 indicates the price of the item in the cart. The price indicated by the price graphical element 530 may reflect the price of one unit of the item, or the total price of the quantity of the item in the cart, depending upon the embodiment. For example, if one unit of an item is in the cart and costs $9.99, the price graphical element 530 may indicate the price $9.99, whereas if two units of the item are in the cart, the price graphical element 530 may indicate the price as $19.98, i.e., the total price of two units of the item.

The UI 500 also includes a checkout graphical element 535 with a total price graphical element 540. The checkout graphical element 535 can be selected via user input to the UI 500. Upon selection, the checkout graphical element 535 adjusts the UI 500 to proceed to a payments interface through which the user 204 can place the order as specified by the list of items in the cart. The total price graphical element 540 displays the total price of the items in the cart, factoring for the quantity of each item in the cart. The online concierge system 102 calculates the total price and populates the total price graphical element 540 with the total price. Depending upon the embodiment, the total price graphical element 540 may or may not include an adjustment to factor for an expected tax.

The UI 500 also includes a foundational items graphical element 545, which can include a descriptive graphical element 550. The foundational items graphical element 545 visually distinguishes foundational items in the cart from items that are not foundational. For example, in visually distinguishing foundational items in the cart from items that are not foundational, the foundational items graphical element 545 may be a box that surrounds the foundational items in the cart, which the UI 500 may group together in the list, such as at the top of the list. Additionally or alternatively, the foundational items graphical element 545 may be a different color than some or all other graphical elements in the UI 500. For example, the foundational items graphical element 550 may be green, while all other graphical elements in the UI 500 are not green. The descriptive graphical element 550 is an aspect of the foundational items graphical element 545 according to one or more embodiments. The descriptive graphical element 550 may include text indicating the foundational items graphical element 545, such as “foundational” or “foundational items.” In one or more embodiments, the descriptive graphical element 550 is selectable, such as via user input to the UI 500. Upon selection, the descriptive graphical element 550 provides one or more of a description of foundational items and one or more foundational item options. The one or more foundational item options may include adjusting the set of foundational items in the cart, saving the set of foundational items, selecting or providing one or more potential substitute items for one or more foundational items, and so on.

### Processes

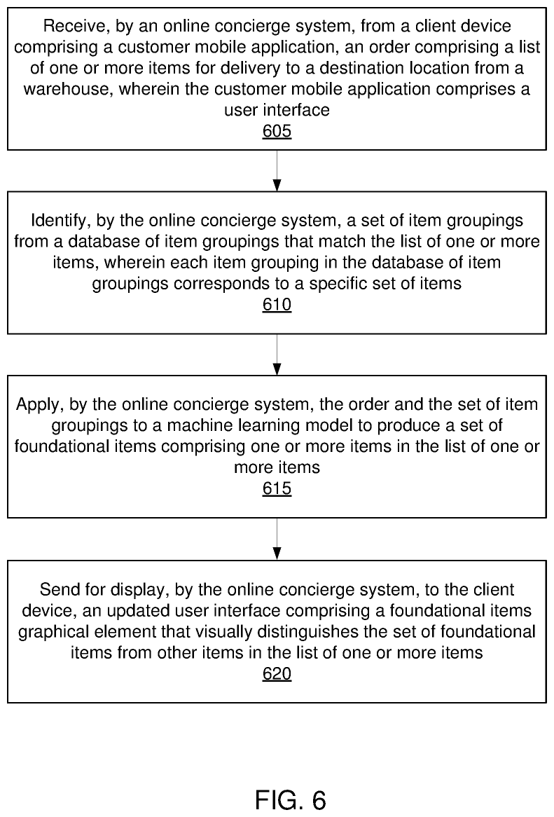

FIG. 6 is a flowchart of one embodiment of a method for identifying and handling foundational items. In various embodiments, the method includes different or additional steps than those described in conjunction with FIG. 6. Further, in some embodiments, the steps of the method may be performed in different orders than the order described in conjunction with FIG. 6. The method described in conjunction with FIG. 6 may be carried out by the online concierge system 102 in various embodiments, while in other embodiments, the steps of the method are performed by any online system, or by a client device 110.

The online concierge system 102 receives 605, from a client device comprising a CMA 206, an order comprising a list of one or more items for delivery to a destination location from a warehouse, wherein the CMA 206 comprises a user interface. For example, the user interface may be UI 500. The online concierge system 102 identifies 610 a set of item groupings from a database of item groupings that match the list of one or more items. Each item grouping in the database of item groupings corresponds to a specific set of items. The online concierge system 102 applies 615 the order and the set of item groupings to a machine learning model to produce a set of foundational items. The set of foundational items includes one or more items in the list of one or more items. In one or more embodiments, the machine learning model is the machine-learned foundational item model. The online concierge system 102 sends 620 for display, to the client device, an updated user interface comprising a foundational items graphical element that visually distinguishes the set of foundational items from other items in the list of one or more items.

In one or more embodiments, the online concierge system 102 determines that a particular foundational item in the set of foundational items is unavailable. The online concierge system 102, responsive to determining the particular foundational item is unavailable, performs a remedial action.

In one or more embodiments, the remedial action includes the online concierge system 102 identifying one or more item substitutes for the particular foundational item. The online concierge system 120 sends, to the client device, a notification that the particular foundational item is unavailable. The notification includes an indication of the one or more item substitutes. The online concierge system 120 receives, from the client device, one or more of an instruction to cancel the order and an instruction to replace the particular foundational item with a particular item substitute of the one or more item substitutes.

In one or more embodiments, the remedial action includes the online concierge system 102 identifying one or more alternative item groupings that include the particular foundational item. The online concierge system 102 sends, to the client device, a notification that the particular foundational item is unavailable. The notification includes an indication of the one or more alternative item groupings.

In one or more embodiments, the remedial action includes the online concierge system 102 identifying an alternative warehouse at which the particular foundational item is available. The online concierge system 102 sends, to a shopper client device that includes the SMA 212, an instruction to replace the warehouse with the alternative warehouse for fulfillment of the order.

In one or more embodiments, identifying, by the online concierge system 102, a set of item groupings from a database of item groupings that match the list of one or more items, includes the online concierge system 102 identifying a particular item grouping in the database of item groupings that comprises one item in the list of one or more items.

In one or more embodiments, the updated user interface comprises a visualization of the list of one or more items, the set of foundational items in the list of one or more items are grouped in the visualization of the list of one or more items, and the foundational items graphical element includes a box surrounding the set of foundational items in the visualization of the list of one or more items.

In one or more embodiments, the online concierge system 102 receives, from the client device, a notification that a particular foundational item in the set of foundational items is not foundational. The online concierge system 102 adjusts the set of foundational items to remove the particular foundational item.

In one or more embodiments, the order includes contextual data. The online concierge system 102 identifies foundational item attributes based on the contextual data. The contextual data includes third party system data received from the client device. The online concierge system 102 applying the order and the set of item groupings to the machine learning model to produce the set of foundational items comprising one or more items in the list of one or more items, further comprises applying the foundational item attributes to the machine learning model.

In one or more embodiments, the CMA 206 is associated with a user profile, and the online concierge system 102 identifying the set of item groupings is based on the user profile.

In one or more embodiments, the online concierge system 102 applies a set of heuristic rules to the order to identify an additional foundational item.

In one or more embodiments, the online concierge system 102 receives, from the client device, feedback data for the order. The online concierge system 102 updates the machine learning model based on the feedback data.

The techniques described herein provide for machine learned foundational item substitution management. This reduces item waste by reducing rates of failed orders. The described techniques overcome technical challenges, such as optimizing use and consumption of computing resources (e.g., processing power, network bandwidth, etc.) when identifying which items in an order cannot be unfulfilled based on sparse information about the order and without requiring human input.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving, by an online concierge system, from a client device comprising a customer mobile application, an order comprising a list of one or more items for delivery to a destination location from a warehouse, wherein the customer mobile application comprises a user interface;
identifying, by the online concierge system, a set of item groupings from a database of item groupings that match the list of one or more items, wherein each item grouping in the database of item groupings corresponds to a specific set of items;
applying, by the online concierge system, the order and the set of item groupings to a machine learning model to produce a set of foundational items comprising one or more items in the list of one or more items; and
sending for display, by the online concierge system, to the client device, an updated user interface comprising a foundational items graphical element that visually distinguishes the set of foundational items from other items in the list of one or more items.

2. The method of claim 1, further comprising:
determining, by the online concierge system, that a particular foundational item in the set of foundational items is unavailable; and
responsive to determining the particular foundational item is unavailable, performing, by the online concierge system, a remedial action.

3. The method of claim 2, wherein performing the remedial action comprises:
identifying, by the online concierge system, one or more item substitutes for the particular foundational item;
sending, by the online concierge system, to the client device, a notification that the particular foundational item is unavailable, the notification comprising an indication of the one or more item substitutes; and
receiving, by the online concierge system, from the client device, one or more of an instruction to cancel the order and an instruction to replace the particular foundational item with a particular item substitute of the one or more item substitutes.

4. The method of claim 2, wherein performing the remedial action comprises:
identifying, by the online concierge system, one or more alternative item groupings that include the particular foundational item; and
sending, by the online concierge system, to the client device, a notification that the particular foundational item is unavailable, the notification comprising an indication of the one or more alternative item groupings.

5. The method of claim 2, wherein performing the remedial action comprises:
identifying, by the online concierge system, an alternative warehouse at which the particular foundational item is available; and
sending, to a shopper client device comprising a shopper mobile application, an instruction to replace the warehouse with the alternative warehouse for fulfillment of the order.

6. The method of claim 1, wherein identifying, by the online concierge system, a set of item groupings from a database of item groupings that match the list of one or more items, comprises:
identifying, by the online concierge system, a particular item grouping in the database of item groupings that comprises one item in the list of one or more items.

7. The method of claim 1, wherein the updated user interface comprises a visualization of the list of one or more items, the set of foundational items in the list of one or more items are grouped in the visualization of the list of one or more items, and the foundational items graphical element comprises a box surrounding the set of foundational items in the visualization of the list of one or more items.

8. The method of claim 1, further comprising:
receiving, by the online concierge system, from the client device, a notification that a particular foundational item in the set of foundational items is not foundational;
adjusting, by the online concierge system, the set of foundational items to remove the particular foundational item; and
updating, by the online concierge system, the updated user interface based on the adjusted set of foundational items.

9. The method of claim 1, wherein the order further comprises contextual data, the method further comprising:
identifying, by the online concierge system, foundational item attributes based on the contextual data, wherein the contextual data comprises third party system data received from the client device;
wherein applying, by the online concierge system, the order and the set of item groupings to the machine learning model to produce the set of foundational items comprising one or more items in the list of one or more items, further comprises applying the foundational item attributes to the machine learning model.

10. The method of claim 1, wherein the customer mobile application is associated with a user profile, and identifying the set of item groupings is based on the user profile.

11. The method of claim 1, further comprising:
applying, by the online concierge system, a set of heuristic rules to the order to identify an additional foundational item.

12. The method of claim 1, further comprising:
receiving, by the online concierge system, from the client device, feedback data for the order; and
updating, by the online concierge system, the machine learning model based on the feedback data.

13. A computer program product comprising a non-transitory computer readable storage medium having instructions encoded thereon that, when executed by a processor, cause the processor to:
receive, by an online concierge system, from a client device comprising a customer mobile application, an order comprising a list of one or more items for delivery to a destination location from a warehouse, wherein the customer mobile application comprises a user interface;
identify, by the online concierge system, a set of item groupings from a database of item groupings that match the list of one or more items, wherein each item grouping in the database of item groupings corresponds to a specific set of items;
apply, by the online concierge system, the order and the set of item groupings to a machine learning model to produce a set of foundational items comprising one or more items in the list of one or more items; and
send for display, by the online concierge system, to the client device, an updated user interface comprising a foundational items graphical element that visually distinguishes the set of foundational items from other items in the list of one or more items.

14. The computer program product of claim 13, the instructions further comprising instructions that, when executed by the processor, cause the processor to:
determine, by the online concierge system, that a particular foundational item in the set of foundational items is unavailable; and
responsive to determining the particular foundational item is unavailable, perform, by the online concierge system, a remedial action.

15. The computer program product of claim 14, wherein instructions to perform the remedial action comprise instructions that, when executed by the processor, cause the processor to:
identify, by the online concierge system, one or more item substitutes for the particular foundational item;
send, by the online concierge system, to the client device, a notification that the particular foundational item is unavailable, the notification comprising an indication of the one or more item substitutes; and
receive, by the online concierge system, from the client device, one or more of an instruction to cancel the order and an instruction to replace the particular foundational item with a particular item substitute of the one or more item substitutes.

16. The computer program product of claim 14, wherein instructions to perform the remedial action comprise instructions that, when executed by the processor, cause the processor to:
identify, by the online concierge system, one or more alternative item groupings that include the particular foundational item; and
send, by the online concierge system, to the client device, a notification that the particular foundational item is unavailable, the notification comprising an indication of the one or more alternative item groupings.

17. The computer program product of claim 14, wherein instructions to perform the remedial action comprise instructions that, when executed by the processor, cause the processor to:
identify, by the online concierge system, an alternative warehouse at which the particular foundational item is available; and
send, to a shopper client device comprising a shopper mobile application, an instruction to replace the warehouse with the alternative warehouse for fulfillment of the order.

18. The computer program product of claim 13, wherein the order further comprises contextual data, the instructions further comprising instructions that, when executed by the processor, cause the processor to:
identify, by the online concierge system, foundational item attributes based on the contextual data, wherein the contextual data comprises third party system data received from the client device;
wherein the instructions to apply, by the online concierge system, the order and the set of item groupings to the machine learning model to produce the set of foundational items comprising one or more items in the list of one or more items, further comprise instructions that, when executed by the processor, cause the processor to apply the foundational item attributes to the machine learning model.

19. The computer program product of claim 13, the instructions further comprising instructions that, when executed by the processor, cause the processor to:
apply, by the online concierge system, a set of heuristic rules to the order to identify an additional foundational item.

20. An online concierge system, comprising:
a processor; and
a non-transitory computer-readable storage medium having instructions encoded thereon that, when executed by the processor, cause the online concierge system to:
receive, by the online concierge system, from a client device comprising a customer mobile application, an order comprising a list of one or more items for delivery to a destination location from a warehouse, wherein the customer mobile application comprises a user interface;
identify, by the online concierge system, a set of item groupings from a database of item groupings that match the list of one or more items, wherein each item grouping in the database of item groupings corresponds to a specific set of items;
apply, by the online concierge system, the order and the set of item groupings to a machine learning model to produce a set of foundational items comprising one or more items in the list of one or more items; and
send for display, by the online concierge system, to the client device, an updated user interface comprising a foundational items graphical element that visually distinguishes the set of foundational items from other items in the list of one or more items.
